(19) United States
(12) Patent Application Publication
(10) Pub. No.: US 2005/0122495 A1
(43) Pub. Date: Jun. 9, 2005

(54) Method and device for imaging a mask onto a substrate

(76) Inventors: Roland Kaplan, Heidelberg (DE); Juergen Sollner, Heidelberg (DE)

Correspondence Address: Jordan & Hamburg, 122 East 42nd Street, New York, NY, 10168, US

(21) Appl. No.: 10/511,226

(22) PCT Filed: Apr. 11, 2003
(86) PCT No.: PCT/EP03/03775

(30) Foreign Application Priority Data
Apr. 11, 2002 (DE) 102 16 096.1

(51) Int. Cl. G03B 27/52

(52) U.S. Cl. 355/52; 355/55; 355/53

(57) ABSTRACT

The invention relates to a method for imaging a mask (1) onto a substrate (2) by means of an illuminating unit (8) and an optical unit (9). The invention also relates to a device for carrying out the method. The aim of the invention is to create a method and a device which enable the mask (1) and the smaller structures thereof to be imaged onto the substrate (2) in a precise manner, with high functional reliability, and which enable the distortions of the substrate (2) to be corrected. To this end, the illuminating unit (8) and the optical unit (9) are displaced in relation to the mask (1) and the substrate (2), distortions of the substrate (2) are detected, and the imaging of the mask (1) is distorted according to the detected distortions by means of the optical unit (9) and is adapted to the distortions of the substrate (2).

The invention relates to a method for imaging a mask on a substrate in accordance with the features cited in the preamble to patent claim 1. The invention furthermore relates to an apparatus for performing the method.

Known from DE 39 10 048 C2 are such a method and an apparatus for performing said method. In this case it is an orientation system in photolithography with which a mask, a large area substrate, and a transfer system that contains an illumination unit and an optical unit can be oriented relative to one another, whereby structures of the mask can be transferred in small areas to the substrate. During the transfer or imaging of the structure of the mask onto the substrate, a marking is applied thereto, and during scanning of the structures of the mask there is continuous orientation of the mask, relative to the area, with respect to the substrate. The mutual orientation of the mask and the substrate requires a certain complexity in terms of equipment, and in particular there are limits with regard to the transfer speed and the attainable throughput due to time delays and inertia with the orientation system.

In the following, a template that is used for producing for instance printed circuit boards or flat screens and that is embodied as a film, emulsion mask, chrome mask, or the like will be called a mask. Such masks contain small structures such as for instance tracks or in general geometric structures that are to be imaged or copied onto a substrate. The typical size of such structures depends on the application and in printed circuit board technology today is for instance 10 to 50 mm. In production of flat screens, structure sizes go down to 1 to 2 mm. The tolerance when placing the structures, i.e., their positional accuracy, is clearly less than the structure sizes themselves. Planar plate-shaped production elements or production blanks are used for substrates. Thus for instance the production of printed circuit boards requires multiple copying of very different structures on pre-products, intermediate products, and the final product that forms the base for the electronic components and the required electrical connections. The size of printed circuit boards today is on the order of up to 600×800 mm², and there is talk of multiuse applications due to the aforesaid pre-products, intermediate products, and final products. Likewise, in the production of flat screens very similar method steps occur, whereby clearly smaller dimensions must be observed for the structure sizes and tolerance limits. The following tabular summary identifies typical applications or substrates that are called blanks or blank elements in the following:
1. Printed circuit boards: Structuring of copper surfaces, structuring of flexible printed circuit boards, cross-linking of solder resist or positive lacquer
2. Screen technology: Lacquer image for structuring of metallic or non-conductive layers, cross-linking of color filters, creation of structures on flexible base materials such as e.g. film screens.
3. Microstructure engineering: Creation of working copies, direct lighting of large planar workpieces such as e.g. photovoltaic elements.

Planar flat substrates are generally quite thin and have a thickness of a few mm (micrometers) to several mm (millimeters) and are coated with a light-sensitive layer that is to be structured. The blank elements run through various production steps, whereby high temperature differences and other mechanical stresses can occur. Such stresses can lead to permanent geometric changes. Thus, printed circuit boards for instance are composed of a plurality of layers of base films, and this method is often called pressing. The intermediate products that are composed or pressed in this manner have dimensional deviations that must be taken into account in the next production step so that for instance fine tracks for covering through-contacts that are just as small can be made. Similarly, during production of screens the individual image elements must be contacted.

The distortions in the blank elements that occur in the production process fundamentally limit the minimum reasonably producible structures. In order for the desired functions to be able to be realized by means of the structures of different layers or blank elements, a minimum overlap must be ensured. For this it is necessary that for a minimum structure size Z and taking into account a production tolerance dZ, the associated counter-structure has the size Z, 2×dZ. This ensures that the structures overlap with a positional error dZ. On the other hand, if the deviation between the structure or mask and the blank element is too large, the structures associated with one another do not overlap any longer. Furthermore, the problems inherent in optical imaging must be considered, namely, positional accuracy and image sharpness. This means that the image of the template or mask must be imaged as positionally accurate as possible on the structure or the blank and the focus plane of the image must lie on the light-sensitive layer of the substrate.

Starting at this point, the object of the invention is to embody both the method and the apparatus such that precise imaging of the templates or masks and their small structures on the substrate or blank element is attained with high functional security, while taking into consideration the factors cited in the foregoing. Creating precise copies of small structures on preferably large substrates and/or blank elements should be possible with no problems. It should be possible to image and/or create on the substrate the smallest possible structures for the mask with high positional accuracy. Furthermore, the method and the apparatus should be economical to employ and should enable high throughput.

This object is attained in terms of the method in accordance with the features cited in patent claim 1. The object is attained in terms of the apparatus in accordance with the features cited in patent claim 9.

The proposed method and the apparatus proposed for performing said method make possible the creation of precise copies of small structures on in particular large substrates and/or the creation of small structures on a distorted substrate with high positional accuracy and with a comparatively low complexity. In accordance with the invention, the mask, which represents the original in the target dimensions, is corrected and/or distorted during the imaging by means of the optical unit or in the copying process, and thus the image of the mask is adapted on the substrate or the blank element to its individual distortions. Thus even the smallest structures are created on the distorted substrate with high positional accuracy, whereby in the following this process shall be called distortion of the mask image.

In accordance with the invention, the image of the mask can be distorted individually in any direction and thereby corrected and in particular scaled such that distortions of the substrate are compensated. In accordance with the invention, height and width of the mask image or its dimensions in the X-plane and the Y-plane of the substrate are adapted to its distortions, if any. Furthermore, compensation of higher orders can be performed in a preferred manner, whereby the width of the image is a function of the height of the image or vice versa. Thus, in particular a rectangular template or mask is transformed corresponding to the established distortions of the substrate into a parallelogram or in general into a trapezoid. The suggested distortion and/or transformation is inventively individually determined for each blank element and/or for each partial area of it or of the substrate. The correction and/or transformation parameters determined in particular in accordance with the distortions of the substrate are used to correct the mask image during the imaging or copying process. The distortion of the mask image and/or the orientation is performed in accordance with the invention by overlapping and/or continuous joining of individual images, each of which is smaller than the overall image. In the framework of the invention, the distortions are performed in particular by translation and/or rotation and/or shearing and/or direction-independent scaling. The method and/or the apparatus are not limited to certain structure sizes, nor must method-related tolerance limits be observed. In addition, there are no limits in terms of the size or dimensions of the substrate.

Both the mask and the substrate preferably have mechanical apparatus or markings so that the image of the mask or template is imaged on the substrate or blanks as positionally accurate as possible and an exact orientation is attained. In the most simple case, reference bores can be provided for this, by means of which the position of the mask and the blank element are fixed individually by means of pins. For very thin blank elements and the large distortions that occur with them, this is not useful since the substrate could undulate. Therefore, for very thin blank elements, markings are applied, for instance fiduciary points or orientation marks or alignment markings that can be evaluated using associated optics and a camera system. Information about the position of the mask and/or the position of the blank element is determined by measuring such markings. The corresponding measurement values are used to calculate the distortion, such as e.g. the displacement or the rotation of the blank element. In the inventive method and the apparatus suggested for performing the method, simple optical components are used and the mask is inventively distorted, and is copied, taking into consideration the detected distortions of the blank element, at the required correct position of the blank element. Furthermore, in accordance with the invention, the focus plane of the image is imaged on the light-sensitive surface of the substrate for obtaining an optimum image, in particular with correct structure size, edge quality and edge slope on the blank element. For this, a focusing apparatus is provided by means of which the length of the optical path between the mask and the blank element is rendered variable without the imaging scale being affected. The focusing apparatus is usefully a component of the optical element.

In one preferred embodiment of the invention, at any time and/or just one small part of the mask is imaged by means of the optical unit on the blank element. The overall image on the blank element is created by relative movement between mask and substrate on the one hand and the optical unit on the other hand, which is also called imaging optics. It is particularly important that the position of the mask relative to the substrate is not changed during the exposure. The mechanical movement between the optical unit, preferably also the illumination unit, on the one hand, and the mask and the substrate on the other hand is performed advantageously as slowly as possible, whereby the (quite high) speeds and accelerations that are fundamentally possible with the mechanical system are not used in order to keep the forces on the optical components and the mask and substrate as low as possible. The mechanical system preferably contains a cage by means of which the mask and the substrate are arranged fixedly and securely to one another in the manner necessary. For one thing, the goal is an image field that is as large as possible in order to keep the required mechanical movements or cage movements for composing the overall image small. For another thing, a small image field is desired so that the inventive distortion, in particular scaling, can be performed. The small image field required for the distortion is moved relatively rapidly over the mask and the blank element by means of the optical unit. For this purpose, a light scan is advantageously provided perpendicular to the direction of movement of the mechanical system or the cage. The movement of the illuminated area on the mask, hereafter called the illumination dot, is composed of two movements. In a useful manner, the mechanical system or the cage moves relative to the optical unit comparatively slowly, specifically on the order of 0.1 to 1 m/sec. In contrast, the illumination dot moves comparatively rapidly relative to the optical unit or the imaging optics, specifically on the order of 1 to 10 m/sec.

In one preferred embodiment of the invention, the image is composed of a plurality of partial images, whereby the following is taken into account for the abutting surfaces on the edges of the partial images. If the partial images do not join together precisely, gaps occur in the overall image, which is then unusable. On the other hand, if the partial images overlap, there can be over-exposure in those areas that are imaged multiple times, whereby the structure sizes can deviate from the target value in multiply exposed areas of the light-sensitive layer of the substrate. Therefore, in accordance with the invention the exposure intensity is reduced in edge areas in which partial images overlap. Advantageously used for this is an illumination unit or a light source that has at least an approximately Gauss-shape beam profile and/or light intensity distribution at least approximately corresponding to a Gaussian distribution curve.

The inventive method and the apparatus proposed for performing said method make it possible to image the mask on the substrate as is and/or taking into account distortions of the substrate or of the blank element, whereby the imaging optics or the optical unit together with the illumination unit are moved relative to the mask and the substrate. In a preferred manner the image field of the imaging optics is smaller than the entire image and yields a predetermined number of individual images. The entire image of the mask is thus composed of individual images. Each individual image is moved in the X/Y-plane on the substrate by means of active displacing elements in the imaging optics or the optical unit. By controlling the aforesaid displacing elements appropriately, the overall image can be composed of the individual images such that the required distortion is achieved in the overall image.

The cited distortion is calculated and/or predetermined by measuring marks, in particular alignment marks, on the mask and the substrate or by assigning distortion values, whereby advantageously a combination of measured values and assigned values can be performed. Based on the cited measurement, relative positions of markings of the mask to markings of the substrate are determined. For the inventive correcting method, the image is distorted such that the markings of the substrate are imaged. In this case the mask and/or the substrate can be corrected.

In a preferred manner, image distortion and/or orientation is performed by overlapping and/or continuous joining of individual images that are each smaller than the overall image of the mask. The distortions are performed in particular by translation, rotation, shearing, or direction-independent scaling. Advantageously, at least nearly constant intensity is defined across the mask surface in the temporal mean by soft shielding of the illumination intensity and/or overlapping the individual illumination dots. The illuminated area of the mask is imaged onto the substrate using the optical unit or imaging optics, whereby the imaging represents the structure of the mask with the intensity course of the illumination on the substrate and/or nearly constant image intensity in the temporal mean is attained on the substrate. In a preferred manner a Gauss-like intensity distribution of the illumination dot is provided, in particular by using a laser for the light source.

Furthermore, in the framework of the invention the movement of the illumination dot on the mask is composed of two movements, whereby advantageously a rapid scanning movement of the illumination and/or the illumination dot occurs and a comparatively slower movement of the mechanical unit, in particular a cage, occurs, to which mechanical unit the mask and the substrate are arranged aligned and fixed. Furthermore provided are a correction unit and a control unit that controls the correction unit depending on the position of the illumination dot on the mask and that is in particular integrated into the optical unit. The combined movement of the illumination dot on the mask is in particular taken into account.

In one preferred embodiment, control of the illumination intensity on the mask occurs by controlling the illumination unit or associated controllable damping elements. This can in particular occur for pulsed lasers by varying the pulse rate. In addition, control of the illumination intensity can be performed as a function of the position of the illumination dot on the mask. Additionally or alternatively, the illumination intensity can be controlled as a function of the speed of the mechanical unit or the cage. This advantageously attains at least nearly constant intensity distribution in the temporal mean on the mask, even if the speed of the mechanical unit is not constant.

Advantageously, the optical path is calibrated, whereby, with a light source of the illumination unit available or provided for this, a reference structure is imaged on a camera preferably fixed on the table of the mechanical unit, which camera is called an alignment camera. Furthermore, alignment of the light path is performed in a useful manner, specifically using the active elements in the optics path and/or the optical unit. Calibration of the optics measuring devices on the reference mark and camera of the table takes place.

In another embodiment of the invention, the optical unit contains two lenses or lens systems in a so-called 4f arrangement, whereby the mask is arranged in the front focal point of the first lens system. The substrate is arranged in the back focal point of the second lens system. The ray path in front of the first lens system or after the second lens system is point-reflected, especially using a retroreflector. Furthermore, it has proved advantageous to combine the imaging optics or the optical unit with a correction unit such that the image is displaced perpendicular to the optical axis in the image plane. For this, the following measures are provided individually or in combination, depending on specific requirements. The ray bundle is displaced parallel to the optical axis by means of a plane-parallel plate by tilting perpendicular to the optical axis. Furthermore, a mirror can be provided that can be tilted perpendicular to the entering and exiting ray bundle. Furthermore, a retroreflector can be provided that is displaceable perpendicular to the optical axis. In addition, for calibrating the optics path, the light path can be lengthened or shortened by means of the imaging optics, specifically preferably by moving the aforesaid retroreflector. In this way in a useful manner the image plane can be imaged precisely on the substrate surface. The setting of the image plane can be adjusted either statically by providing target values or dynamically by positional measurement of the substrate surface.

A plurality of preferably parallel ray paths can be used in a preferred manner for enhancing the throughput of the system or the apparatus. In this case, a plurality of illumination dots are created on the mask by means of the illumination unit, which illumination dots are imaged by a plurality of optical units and/or imaging and correction units on the substrate. In addition, copying of a mask can occur in an advantageous manner in that a plurality of parallel ray paths are created with a plurality of illumination dots on the mask. Also, a mask can be copied in the framework of the invention in that a plurality of parallel ray paths are created on the substrate by means of a beam splitter in the optical unit.

Special designs and further developments of the invention are provided in the subordinate claims and in the following description of the figures.

The invention is explained in greater detail in the following using the exemplary embodiments depicted in the drawings, without this constituting a restriction.

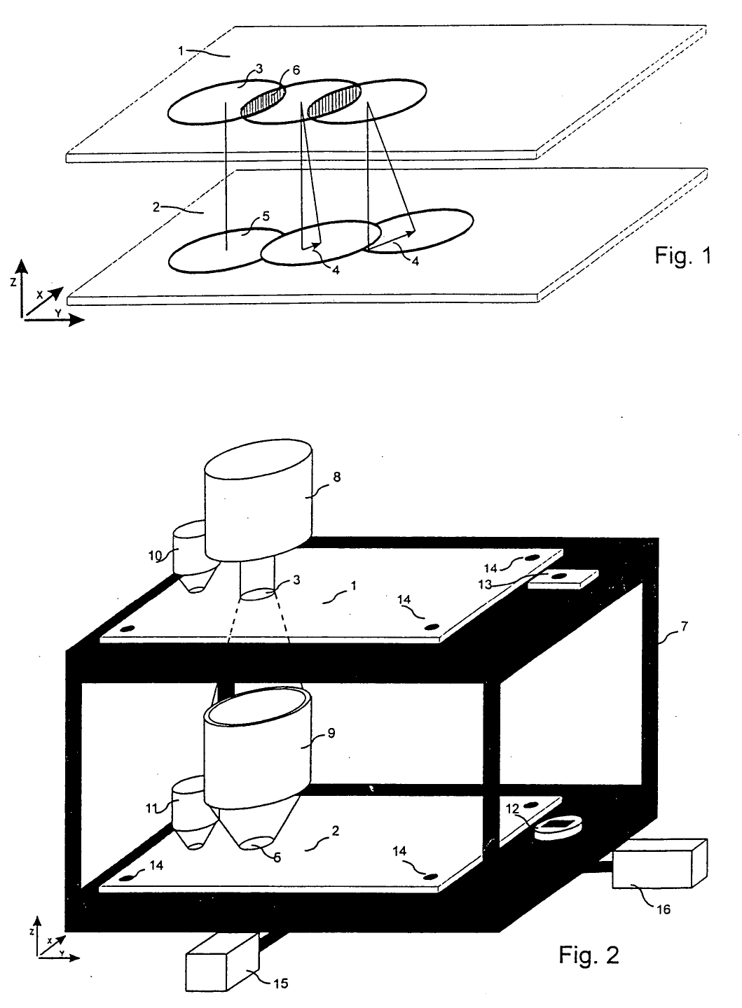

FIG. 1 depicts the principle of a correction or image distortion by joining of individual images;

FIG. 2 is a schematic representation of an exemplary embodiment of the invention;

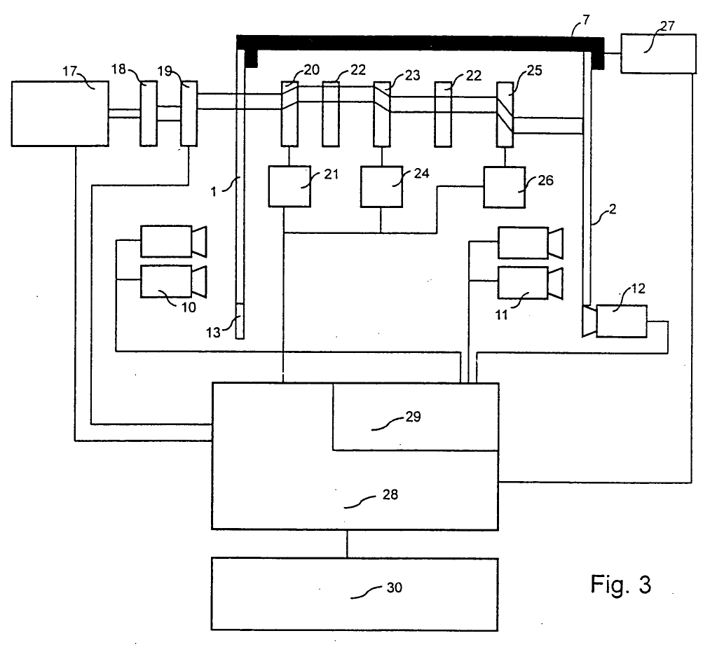

FIG. 3 is a schematic representation of an apparatus for distorted imaging of a mask;

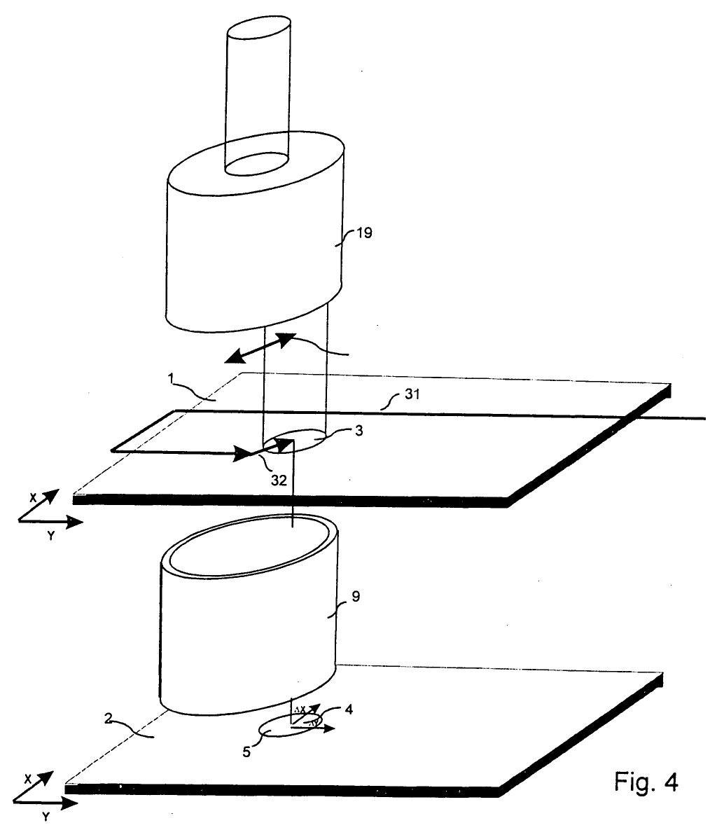

FIG. 4 depicts the principle for vector addition of the illumination position from the position of the mechanical unit and the illumination unit;

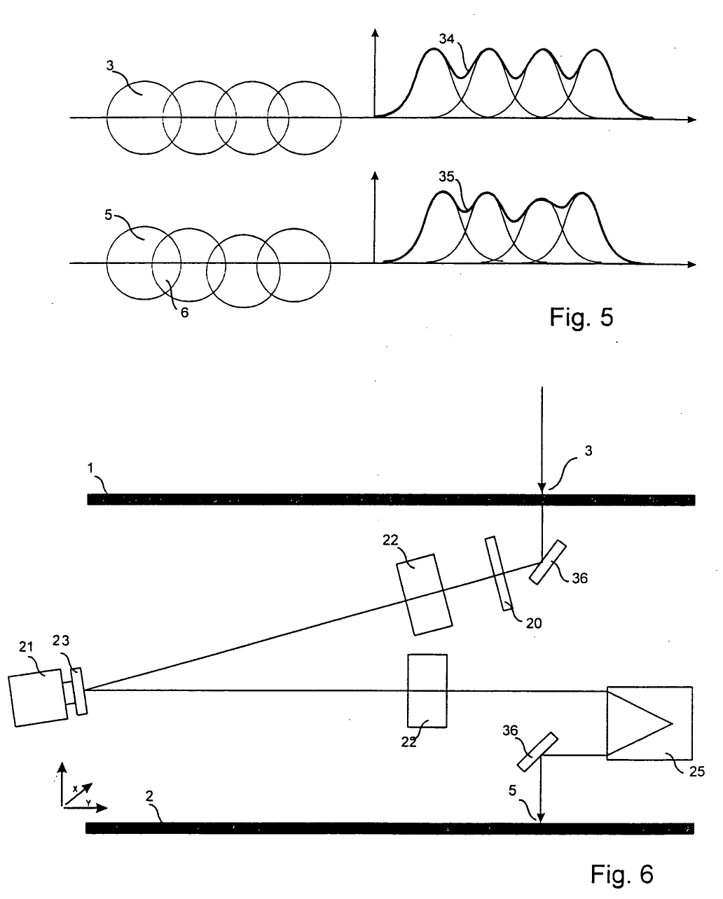

FIG. 5 is a schematic representation of overlapping illumination dots of an illumination unit with Gaussian intensity distribution in one direction in space;

FIG. 6 is an exemplary embodiment of an optical unit with two lens systems in a so-called 4f arrangement with a downstream retroreflector;

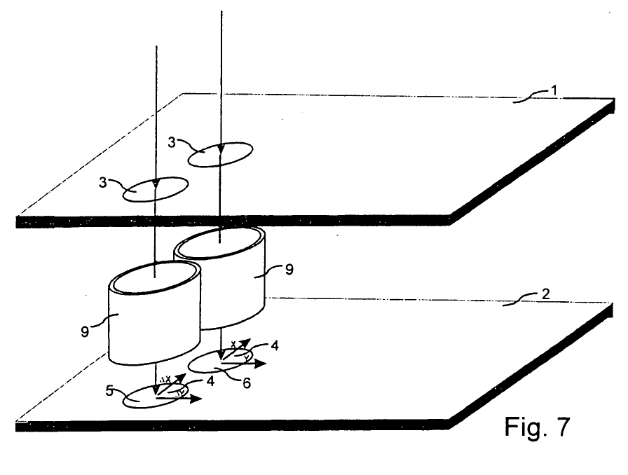

FIG. 7 is a schematic representation of an illumination unit for generating two illumination dots on the mask;

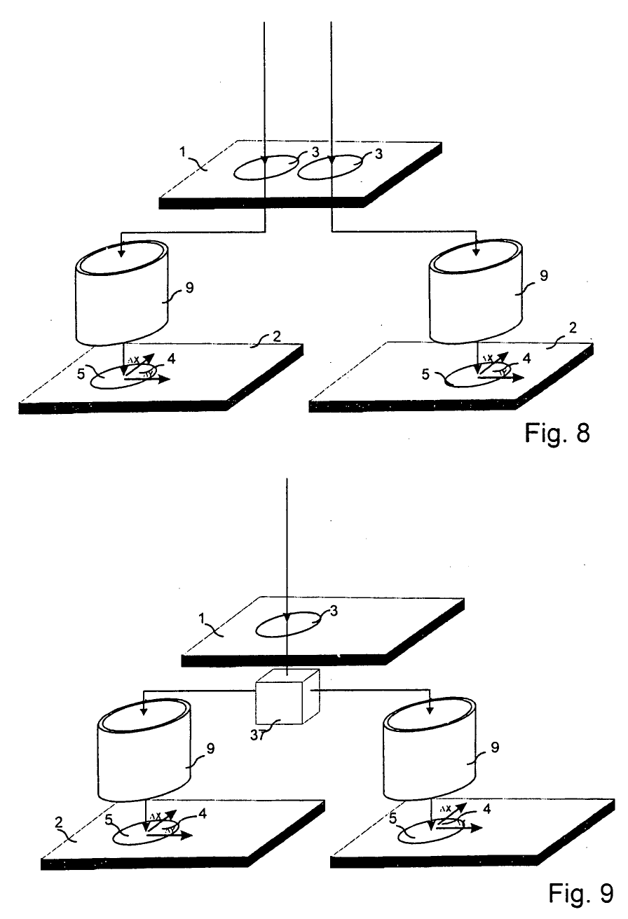

FIGS. 8 and 9 are schematic arrangements for simultaneous copying of masks or for multi-imaging.

FIG. 1 illustrates the principle of image distortion by joining individual images. One partial area of the mask 1 is imaged on the substrate 2, whereby an illumination dot 3 is created on the mask 1 by means of an illumination unit and is imaged on the substrate 2 as an individual image 5. The entire image is composed of overlapping individual images 5, whereby each individual image is an undistorted 1:1 image of the mask or of the associated illumination dot. The distortion of the overall image occurs through a displacement of the individual images 5 on the substrate 2 by a correction vector 4. The distortion of the substrate 2 is calculated by measuring markings, in particular alignment marks, on the mask 1 and the substrate 2 or by specifying distortion values, whereby it is useful that a combination of measurement values and defined values can be used. Based on the measurement, the relative positions of mask marks to substrate marks are determined, whereby in accordance with the correction method the image is distorted such that the mask marks are imaged on the cited substrate marks. The mask 1 or the substrate 2 and if necessary both can be corrected. The cited displacement effects an indistinctness in the overlapping area 6, whereby the maximum offset of two adjacent individual images 5 is provided according to the tolerable indistinctness and the size of the overlapping area 6.

FIG. 2 is a schematic representation of an exemplary embodiment of the apparatus whose mechanical unit contains a cage 7 by means of which the mask 1 and the substrate 2 are spaced and securely fixed to one another. Arranged separately from the mechanical unit or the cage 7 are an illumination unit 8, an optical unit 9, a mask camera 10, and a substrate camera 11. Furthermore, an alignment camera 12 and a reference mark 13 are securely fixed to the cage 7. An X-drive 15 and a Y-drive 16 are provided for moving the cage 7 in the X/Y plane. The cage 7 and the aforesaid components affixed thereto are inventively relatively movable relative to the other components such as in particular the illumination unit 8, optical unit 9, which are mounted fixed to one another and are in a defined geometric arrangement to one another. Thus the mask 1, the substrate 2, and the alignment camera 12 are arranged, with the cage 7, relatively movable to all other components of the apparatus.

The mask 1 is rear illuminated in a partial area, the cited illumination dot 3, by means of the illumination unit 8. This partial area or illumination dot 5 is imaged undistorted and unenlarged on the substrate 2 via the optical unit 9. The optical unit 9 contains an imaging and correction unit and is disposed in the optical path between the mask 1 and the substrate 2. The individual image is displaced on the substrate 2 in the X/Y plane by means of the aforesaid correction unit. The positions of registration marks 13 are determined on the mask 1 and the substrate 2 by means of the camera and downstream image processing software of an image processing system for determining the distortion thus attained. The control data for the aforesaid imaging and correction unit are recalculated from the positions of the registration marks 14.

For aligning the optics path, the cage 7 is moved into a position in which the reference structure or reference mark 13 is rear illuminated by the illumination unit 8. The reference mark 13 is imaged on the alignment camera 12 by means of the optical unit 9, which forms the imaging and correction unit. By controlling the correction unit of the optical unit appropriately, the image of the reference mark 13 is imaged onto a standard position on the alignment camera 12. Thus the coordinate system of the mask 1 is related to the coordinate system of the substrate 2. The control data obtained in this manner are taken into account as offset values in the correction calculation for the later mask imaging. Then the reference structure or reference mark 13 is moved under the mask measurement camera 10 and the position of the reference mark 13 is measured. This determines the position of the mask camera 10 relative to the reference mark 13. Analogous to this, the substrate camera 11 is moved, whereby especially the position of the CDC chip in the alignment camera 12 is used for reference mark. The thus determined positions of the mask camera 10 and substrate camera 11 are taken into account as offset values during the measurement of alignment marks on the mask and/or masks or on the substrate and/or substrates.

FIG. 3 is a schematic overview of an apparatus for distorted imaging of the mask 1. Provided as light source for the aforesaid illumination unit is a laser 17 that preferably has a mean output of 1 to 10 W in a normal wave range for exposure of printed circuit boards in the range of 350 to 400 nm. The illumination diameter required for the application is adjusted with a beam expansion unit 18. The expanded laser beam is moved perpendicular to the surface of the mask 1 by means of a scanning device 19. As already explained, the mask 1 and the substrate 2 are held securely to the cage 7 of the mechanical unit. Arranged in the optical path between the mask 1 and the substrate 2 is the optical unit 9 with active elements for positional correction and for imaging the illumination dot 3 on the substrate 2. The optical unit 9 contains a plane-parallel plate 20 with a 2-axis tilt drive 21, a lens system or a lens 22, a scan mirror 23 with associated 2-axis tilt drive 24, a second lens system 22, and a retroreflector 25 with associated XYZ drive 26. The image field of the image is provided large enough that the entire illuminated area of the mask 1 is imaged on the substrate 2 in every position of the illumination scan. The cage 7 is movable by means of the aforesaid X/Y drive with a positional regulator 27 in the manner necessary independent of the illumination unit 8 and the optical unit 9 relative thereto. The positional control or regulation of the cage 7, the active elements 20, 23, 25 of the optical unit, the laser 17, and the scanning device or the illumination scanner 19 are connected to a computer system 28 and/or are controlled by means of the computer system 28. For determining the measurement data required for the corrections, an image processing system 29 is allocated to or integrated in the computer system 28, whereby the aforesaid cameras are connected to the image processing system 29. The positions of the registration marks in the camera images are calculated by means of the image processing system 29 and with the detected cage position their absolute position on the mask 1 and/or the substrate is calculated. A reference mark 13 is arranged on the plane of the mask 1 of the cage 7 and the alignment camera 12 is arranged on the plane of the substrate 2. The reference mark 13 is imaged by means of the optical unit on the alignment camera 12. In this manner the aforesaid active elements 20, 23, 25 or the optical unit are realigned as needed. The entire computer system 28 is controlled using an operator's computer 13, to which a suitable operator interface, in particular on a screen or monitor, is allocated.

In an advantageous manner, the illumination intensity on the mask 1 is controlled by controlling the illumination source, in particular the laser 17, via the computer system 28. Thus, for instance with a pulsed laser 17, the intensity is influenced by varying the pulse rate or in a CW laser by controllable damping. The system data, in particular the position of the illumination dot on the mask or the speed of the table or the cage 7, are available to the computer system 28 at all times. This is how the intensity is controlled depending on the aforesaid and/or other parameters. In addition, the intensity is adapted to different speeds of the cage 7 such that there is the defined and/or desired intensity distribution in the sum on the mask 1. This ensures that the exposure can be performed during the acceleration and/or braking phase of the cage 7.

The inventive apparatus has the following structure.
1. Illumination path with light source, in particular laser 17, expansion optics or beam expander 18, illumination scanner or scanning device 19.
2. A mask holder that is adapted to various mask types, such as chrome masks, emulsion masks, or films.
3. Optical unit 9 with input optics, X/Y scanner, output optics, and focus device.
4. Substrate holder that is adapted to various blank elements, such as thin films, continuous films, printed circuit boards, or glass substrates.

As FIG. 4 illustrates, the position of the illumination dot 3 on the mask 1 is determined by the X/Y position of the cage and the position of the illumination scanner 19. Strip-wise illumination of the mask 1 is performed by combining a rapid scanning movement 32 with a relatively slow cage movement 31. The optical unit 9 is designed such that it can image the illumination dot 3 in all scanning positions on the substrate 2. The movement of the illumination dot 3 is inventively set such that the illuminated areas overlap. Nearly constant intensity distribution across the surface of the mask to be illuminated is achieved in the temporal mean by this overlapping together with the Gauss-like intensity distribution. Soft shielding of the illumination intensity is provided, whereby the illumination intensity in the edge area of the illumination dot 3 is less by a predefined amount than in the center of the illumination dot 3, preferably corresponding to the Gauss-like intensity distribution of the laser. The illuminated area of the mask 1 is imaged using the optical unit 9 on the substrate, whereby the image is the structure of the mask 2 with the intensity course of the illumination. Thus in the temporal mean an image intensity that is at least nearly constant is attained on the substrate 2.

The intensity of the illumination is controlled by the computer system. This can occur by controlling the illumination source or controllable damping elements, for instance by means of a pulsed laser by varying the pulse rate. In addition, the illumination intensity is controlled as a function of the position of the illumination dot 3 on the mask 1. Furthermore, in the framework of the invention the intensity of the illumination is defined as a function of the speed of the cage, so that a constant intensity distribution is attained in the temporal mean on the mask 1, even if the speed of the cage is not constant. Apart from varying the pulse rate in pulsed lasers, in particular in a CW laser the intensity of the illumination can be defined by controllable damping. The system data, in particular the position of the illumination dot 3 on the mask 1 or the speed of the cage or its table are available to the computer system at all times. This is how it is possible to control the intensity of the illumination as a function of other parameters. The intensity is usefully adapted to different speeds of the cage such that the desired intensity distribution is in the sum on the mask 1. Thus advantageously exposure can be performed during the acceleration and/or braking phase of the cage.

The soft shielding of the illumination intensity and overlapping of the illumination dots is provided in particular by means of a laser whose beam intensity has a Gaussian profile perpendicular to the beam direction. Advantageously, the illumination intensity is controlled, and thus the light intensity is adjusted, by varying the pulse rate of the pulsed laser. The rapid movement of the illumination dot 3 compared to the cage movement is preferably produced by deflection on a scanning mirror of the illumination scanner 19.

For the inventive correction method, the image on the substrate is distorted such that the mask marks are imaged on the substrate marks, whereby it is unimportant whether the mask 1, the substrate 2, or both are corrected. These different correction options require that the correction vector Dx and Dy are a function of the position of the illumination dot (xb, yb) on the mask 2 according to the following equation:
Dx=f₁(x_{b}, y_{b})
Dy=f₂(x_{b}, y_{b})

The illumination position is added vectorally from the cage position and the scan position. A correction device and control are used such that depending on the position of the illumination dot 3 on the mask 1, the correction unit of the optical unit 9 is controlled appropriately, whereby in particular the movement explained in the foregoing is taken into account. The correction unit is designed such that both the rapid scanning movement and the comparatively slower cage movement 31 can occur. Controlling the correction device ensures that the position of the illumination dot is determined from the position of the table or cage and the scanning position. From these positions, preferably in real time and taking into account the provided corrections, the control signals for the correction unit are calculated and produced, specifically advantageously in accordance with the following equation:
=+

In order to ensure long-term stability of the apparatus, the mechanics unit or the cage 7 contains the reference mark 13 and the alignment camera 12. The reference mark 13 is arranged on the mask plane and the alignment camera 12 is mounted on the substrate plane. By imaging the reference structure or reference mark, in particular with the exposure source contained in the illumination unit 8 or alternatively with a separate exposure source, on the fixed alignment camera 12, calibration of the optics path is achieved in a preferable manner. Realignment of the optics path between the mask 1 and the substrate 2 occurs advantageously using one of the active elements of the optical unit 9. The calibration of the optics measurement devices is performed advantageously by means of the reference mark 13 and the table camera and/or the alignment camera, which is arranged on the substrate plane. The cage position in the X/Y plane is measured continuously using a measurement system. The aforesaid cameras and the measurement system are connected to the computer system by means of which the measurement values are evaluated and the drives of the cage and the correction devices are controlled corresponding to correction values and/or correction vectors thus obtained.

Advantageously, a desired image distortion and orientation is performed by overlapping or continuous joining of individual images that are smaller than the overall image. Special cases for the distortions inventively provided for correction are translation, rotation, shearing, and direction-independent scaling. Advantageously, nearly constant intensity is attained across the mask surface in the temporal mean through so-called soft shielding of the illumination intensity and overlapping the illumination dots 3. The illuminated area or illumination dot 3 of the mask is imaged onto the substrate 2 using the imaging optics. The image thus produced is the structure of the mask with the intensity course of the illumination. Advantageously at least nearly constant intensity is attained in the temporal mean on the substrate 2. Advantageously, used for the light source is a laser whose beam intensity has a Gauss-like profile perpendicular to the beam direction. In addition, in a preferred manner the light intensity can be defined in particular by varying the pulse rate of a pulsed laser. The rapid movement of the illumination dot on the mask 1 is produced in particular by deflection by means of a scanning mirror of the illumination scanner.

FIG. 5 illustrates the overlapping for instance in one direction in space of illumination dots 3, whereby the basis for one illumination is Gaussian profiles or a Gaussian intensity distribution. Due to the defined overlapping of the curves, the cumulative intensity 34 on the mask is sufficiently constant up to a residual ripple. The smaller the residual ripple desired, the greater the defined overlapping area 6 of the Gaussian profile. The overlapping area changes when there is a correction of the individual images 5, that is, a displacement in the X/Y plane. The change in the overlapping area 6 is small relative to the absolute size. Thus there is only a slight change in the residual ripple, so that the light intensity 35 on the substrate is at least nearly constant. It has been established that the image on the substrate is the structure of the mask with the intensity course of the illumination. Thus a nearly constant image intensity in the temporal mean is attained on the substrate.

FIG. 6 illustrates an exemplary embodiment of the optical unit containing two lens systems 22, each of which can also be embodied as individual lenses. The two lens systems 22, with a retroreflector downstream in the light path, form a so-called 4-fold arrangement. With such an arrangement, a nearly 1:1 individual image 5 is produced on the substrate 2 by the object or the illumination dot 3 of the substrate 1. Such an image is undistorted and not point-mirrored. By displacing the retroreflector 25 in the Y direction, the image plane is adjusted onto the substrate 2. In combination with the measurement system, with which the position of the substrate surface is determined in the Z direction, in the framework of the invention the image plane can be adjusted once or readjusted continuously. Provided in the optical path are three active elements that are contained individually or in various combinations, in particular in the optical unit, depending on application. The image field and/or the image in the X/Y plane is displaced with at least one, preferably all of the active elements. Thus the image field is displaced by tilting the axis-parallel plate 20 perpendicular to the optics axis. The image field is also displaced by tilting the scanning mirror 23 perpendicular to entering and reflected beam by means of the 2-axis tilt drive 21.

In addition, the image field is displaced by displacing the retroreflector 25 in the X/Z plane.

Furthermore, advantageously the illumination speed, and thus the throughput of the apparatus, can be increased in that multiple imaging and correction units are provided in parallel. Multiple illumination dots are produced on the mask that are imaged by multiple imaging and correction units on the substrate. As FIG. 7 illustrates, for this the illumination unit is embodied such that at least two illumination dots 3 are produced on the mask. The correction values or vectors 4 are defined independent of one another in a preferred manner by means of the two separate optical units 9.

FIGS. 8 and 9 illustrate arrangements for simultaneous copying of the masks. At least two, when required also more, imaging and correction units are arranged such that simultaneous reproduction of one mask 1 is performed on one or more substrates 2. FIG. 8 provides the example of two-fold imaging, whereby two illumination dots 3 are present due to two parallel ray paths. In accordance with FIG. 9, a single illumination dot 3 is produced on the mask 1 and the optical unit contains a beam splitter 37 by means of which two parallel ray paths are produced by means of the optical unit 9 for producing two individual images 5. It is understood that in the framework of the invention a larger number of individual images can be produced analogously instead of two individual images.

### Legend

1 Mask
2 Substrate/blank element
3 Illumination dot
4 Correction vector
5 Individual image
6 Overlapping area
7 Mechanical unit/cage
8 Illumination unit
9 Optical unit/imaging and correction unit
10 Mask camera
11 Substrate camera
12 Calibration camera
13 Reference mark
14 Registration mark
15 X drive
16 Y drive
17 Laser
18 Beam expander unit
19 Illumination scanner
20 Displacement element/plane-parallel plate
21 2-axis tilt drive of 20
22 Lens system/lens
23 Displacement element/scanning mirror
24 2-axis tilt drive of 23
25 Displacement element/retroreflector
26 XYZ drive of 25
27 Position regulator for cage drive
28 Computer system
29 Image processing system
30 Operator's computer with operator interface
31 Cage movement
32 Scanning movement
34 Cumulative intensity on the mask
35 Cumulative intensity on the substrate
36 Mirror
37 Beam splitter

1-17. (canceled)

18. Method for imaging a mask on a substrate by means of an illumination unit comprising an illumination source and an optical unit, comprising moving said illumination unit and said optical unit relative to said mask and said substrate and detecting distortions of said substrate, distorting the image of said mask to adapt the image to the distortions of said substrate by means of said optical unit, wherein illumination dots are created on said mask and, furthermore, individual images are created on said substrate that overlap in the edge areas, providing that illumination intensity in an edge area of said illumination dots be less by a predefined amount than in the center of said illumination dot and/or that the illumination intensity of the illumination dot have a Gauss-like distribution, and, depending on the distortions of said substrate, displacing the individual images, each of which corresponds to an illumination dot, overlapping and continuously joined to one another on said substrate.

19. Method according to claim 19, wherein said individual images are moved on said substrate by means of active displacing elements and/or by controlling said displacing elements said individual images are combined such that the required distortion of the overall image is attained, whereby each individual image is corrected to an undistorted 1:1 image of said mask.

20. Method according to claim 19, wherein said displacing elements cooperate with the optical unit.

21. Method according to claim 20, further comprising calculating said distortion of said substrate by measurement marks of said mask and said substrate or by assigning distortion values and/or by a combination of measurement marks and assigning distortion values and/or by determining relative positions of marks of said mask to marks of said substrate and/or by effecting said distortion of said image of said mask such that said marks of said mask are imaged on said marks of said substrate, thereby to correct said mask and/or said substrate.

22. Method according to claim 21, wherein the distortion of the image of said mask and/or an orientation is performed by overlapping or continuous joining of individual images that are smaller than the entire image of said mask, whereby said distortions are performed by translation, rotation, shearing, or direction-independent scaling.

23. Method according to claim 22, wherein the illumination intensity of said illumination dots is softly shielded and the illumination source comprises a laser.

24. Method according to claim 23, wherein the movement of said illumination dot on said mask is composed of two movements, and/or the correction of said individual image is performed on said substrate corresponding to the position of said illumination dot on said mask and/or combination of the two movements is taken into account for correcting and/or controlling said illumination dot.

25. Method according to claim 24, wherein the two movements are rapid scanning of the illumination and a slower movement of a mechanical unit receiving said mask and said substrate.

26. Method according to claim 25, further comprising controlling the illumination intensity on said mask by controlling said illumination source or a controllable damping element and/or controlling the illumination intensity as a function of position of said illumination dot on said mask and/or controlling the illumination intensity as a function of the speeds of said mechanical unit receiving said mask and said substrate.

27. Method according to claim 25, wherein the laser is a pulsed laser and further comprising controlling the illumination intensity by controlling pulse rate of the laser.

28. Method according to claim 26 or 27, further comprising calibrating optical path by imaging a reference mark or reference structure by means of an exposure source contained in said illumination unit on an alignment camera that, like said mask and said substrate and together with them, is arranged on said movable mechanical unit and/or realigning the optical path by means of at least one active element of said optical unit, and/or calibrating optical measurement devices by means of an alignment camera and a reference mark that are arranged on said movable mechanical unit.

29. Apparatus for imaging a mask on a substrate, comprising a mechanical unit on which said mask and said substrate are arranged spaced from one another, and that includes at least one drive, an illumination unit for creating an illumination dot on said mask and furthermore includes in an optical path between said mask and said substrate an optical unit by means of which an illumination dot can be imaged on said substrate, said mechanical unit being adapted for fixed unchangeable receiving of said mask and said substrate during imaging, said mechanical unit being movably arranged relative to said illumination unit and said optical unit, which are securely coupled to one another, said optical unit comprising at least one active displacing element for displacing said illumination dot on said substrate, and said displacing element being controllable as a function of distortions of said substrate, whereby illumination dots can be created on said mask by means of said illumination unit and furthermore can be created on said substrate in individual images overlapping edge areas, and said illumination dots can be created with their edge areas overlapping on said mask by means of said illumination unit, wherein in said edge areas the illumination intensity is smaller by a predetermined amount than in the center of said illumination dots, and the individual images, each of which corresponds to an illumination dot, are displaced overlapping and continuously joined to one another on said substrate by means of said active displacing element as a function of the distortions of said substrate.

30. Apparatus in accordance with claim 29, wherein image field of said optical unit and/or the individual image created by means thereof is smaller than the entire image of said mask, whereby the entire image of said mask can be composed of a predetermined number of the aforesaid individual images, and further comprising a computer system for controlling said active displacing element so that, depending on established distortions and/or corresponding thereto, a distortion of an entire image of said mask can be effected by combining correspondingly deflected said individual images.

31. Apparatus in accordance with claim 30, wherein said mechanical unit comprises a cage that is adapted for mutual fixed and spaced arrangement of said mask and said substrate, said optical unit is arranged in said cage between said mask said substrate, and/or said optical unit and said illumination unit are mechanically coupled to one another, and are arranged movable relative to said cage, whereby said cage is movable relative to said optical unit and said illumination unit by means of driver.

32. Apparatus according to claim 31, wherein said optical unit comprises imaging optics with two lenses or lens systems, said mask being arranged in a front focal point of the first lens or the first lens system and said substrate being arranged in a back focal point of the second lens or second lens system, the ray path being point-reflected via a retroreflector in front of said first lens or said first lens system or after said second lens or said second lens system.

33. Apparatus according to claim 31, wherein the imaging optics comprises a 4f arrangement.

34. Apparatus according to claim 33, wherein said optical unit comprises a correction unit for displacing the image perpendicular to the optical axis in the image plane or the displacing elements are operable to effect said displacing.

35. Apparatus according to claim 34, further comprising a plane-parallel plate by means of which a ray bundle is displaceable parallel to an optical axis by tilting of the parallel plate perpendicular to the optical axis, and/or further comprising a mirror that is tiltably arranged perpendicular to entering and exiting ray bundle, and/or further comprising a retroreflector that is displaceable perpendicular to the optical axis.

36. Apparatus according to claim 35, wherein said retroreflector is movably arranged such that the light path in the imaging optics can be lengthened or shortened and thus image plane can be imaged precisely on the surface of said substrate, whereby setting of the image plane can be adjusted statically by providing target values or dynamically by positional measurement of the surface of said substrate.

37. Apparatus according to claim 36, wherein said illumination unit creates at least two illumination dots on said mask and the apparatus further comprises a corresponding number of said optical units with imaging and correction units for creating at least two or more individual images on said substrate.

38. Apparatus according to claim 37, wherein for simultaneous copying of said mask on one or a plurality of said substrates, said illumination unit creates a plurality of illumination dots on said mask, and/or the apparatus comprises a beam splitter arranged in the optical path between said mask and said substrate or substrates such that a plurality of individual images can be created on said substrate or substrates by a plurality of ray paths.
